(19) United States
(12) Patent Application Publication
(10) Pub. No.: US 2010/0176801 A1
(43) Pub. Date: Jul. 15, 2010

(54) MAGNETIC ENCODER

(75) Inventors: Fusayoshi Aruga, Nagano (JP); Katsuya Moriyama, Nagano (JP); Naoyuki Noguchi, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/995,019

(22) PCT Filed: Jul. 4, 2006
(86) PCT No.: PCT/JP2006/313274

§ 371 Date: Mar. 31, 2010

(30) Foreign Application Priority Data
Jul. 8, 2005 (JP) 2005-200899

(51) Int. Cl. G01D 5/12; G01B 7/14; G01B 7/30

(52) U.S. Cl. 324/207.22

(57) ABSTRACT

In a magnetic encoder (1), a permanent magnet (20) as a magnetic scale is provided with three rows of tracks (21) wherein N poles and S poles are alternately arranged along a shift direction. In the permanent magnet (20), at end portions (211) in the width direction of the tracks (21A, 21B, 21C), a rotating magnetic field wherein a planar direction changes is formed, and a sensor plane (16) of a magnetic sensor (15) faces a boundary portion (212) between the tracks (21A, 21B, 21C). Thus, detection accuracy of the magnetic encoder of the rotating magnetic field detection type is improved.

### CROSS REFERENCE TO RELATED APPLICATIONS

This is a U.S. national stage of application No. PCT/JP2006/313274, filed on Jul. 4, 2006, the entire contents of which are incorporated by reference and priority to which is claimed herein. Priority under 35 U.S.C. §119(a) and 35 U.S.C. §365(b) is hereby claimed from Japanese Application No. JP-2005-200899, filed Jul. 8, 2005, the disclosure of which is also incorporated herein by reference.

### TECHNICAL FIELD OF THE INVENTION

At least an embodiment of the present invention relates to a magnetic encoder comprising a magnetic sensor which is provided with a magneto-resistive element on its sensor face and a permanent magnet which is moved relative to the magnetic sensor.

### BACKGROUND OF THE INVENTION

A magnetic encoder comprises a magnetic sensor which is provided with a magneto-resistive element on its sensor face and a permanent magnet which is moved relative to the magnetic sensor. The permanent magnet is formed with a track having N-poles and S-poles alternately aligned along a moving direction (for example, see Patent References 1, 2 and 3).

Types of the magnetic encoder generally include a type which detects a position in accordance with strength of a magnetic field in a constant direction and a type which detects a direction of a rotating magnetic field with a magnetic field strength higher than a saturation sensitivity region. The latter typical type of the magnetic encoder is a rotary encoder shown in FIG. 11(a). The rotary encoder 101 is formed with a permanent magnet 120 which is provided with two magnetic poles on an upper end face 151 of a rotation body 105. A magnetic sensor 125 detects a direction of the rotating magnetic field due to rotation of the rotation body 105 to detect a rotation number of the rotation body 105.

A principle for detecting the direction of the rotating magnetic field is as follows. Firstly, as shown in FIG. 12(a), an electric current shown by the arrow “A” is supplied to a magneto-resistance pattern 301 made of ferromagnetic metal and, in addition, as shown in FIG. 12(b), a magnetic field strength “H” with which a resistance value is saturated is applied. In this case, there is a relationship shown by the following expression between an angle θ formed by the magnetic field and the electric current direction and a resistance value “R” of the magneto-resistance pattern:

R=R₀−k×sin² θ
R₀: a resistance value in a non-magnetic field
K: a constant when higher than the saturation sensitivity region. Therefore, when the angle θ is varied, the resistance value “R” is varied as shown in FIG. 12(c) and thus the rotation number of the rotation body can be detected by the magnetic sensor. Further, in the structure which is disclosed in the Patent Reference 3, when a gap space dimension is reduced to improve the S/N ratio, waveform distortion is increased. However, according to a rotating magnetic field detection type encoder, a sine-wave component can be stably obtained even though the gap space dimension is reduced.

Further, as shown in FIG. 11(b), when a track 221 having N-poles and S-poles alternately aligned along a moving direction is formed in a permanent magnet 220, magnetic field directions are successively varied between respective magnetic poles in a plane perpendicular to the permanent magnet 220 to form a rotating magnetic field. Therefore, when the magnetic sensor 215 is disposed such that a sensor face 216 is perpendicularly directed to the permanent magnet 220, a linear encoder 201 can be structured.

[Patent Reference 1] Japanese Patent Laid-Open No. Hei 5-172921
[Patent Reference 2] Japanese Patent Laid-Open No. Hei 5-264701
[Patent Reference 3] Japanese Patent Laid-Open No. Hei 6-207834

However, as shown in FIG. 11(b), when the linear encoder 201 is structured such that the sensor face 216 is perpendicularly directed to the permanent magnet 220, the magnetic field may not reach to the saturation sensitivity region at positions far apart from the permanent magnet 220. In this case, the detection accuracy based on the rotating magnetic field is remarkably lowered.

In view of the problems described above, at least an embodiment of the present invention provides a structure which is capable of improving detection accuracy in a magnetic encoder of a rotating magnetic field detection type.

### MEANS TO SOLVE THE PROBLEMS

In order to solve the problems as described above, according to at least an embodiment of the present invention, a magnetic encoder comprises a magnetic sensor which is provided with a magneto-resistive element on a sensor face of the magnetic sensor, and a permanent magnet which is moved relative to the magnetic sensor and which is formed with a track having N-poles and S-poles alternately aligned along a moving direction. The sensor face of the magnetic sensor is oppositely faced to an edge portion in a widthwise direction of the track and the magnetic sensor detects a rotating magnetic field in which a direction of an in-plane direction is changed at the edge portion.

### SUMMARY OF THE INVENTION

The present applicants have researched and examined a magnetic field of a permanent magnet and have found new knowledge that a rotating magnetic field in which a direction of an in-plane direction is changed is formed at an edge portion in a widthwise direction of a track having N-poles and S-poles aligned alternately. At least an embodiment of the present invention is made on the basis of the above-mentioned new knowledge. In a case that a rotating magnetic field in which a direction of an in-plane direction is changed is formed at the edge portion in the widthwise direction of the track, even when a sensor face of a magnetic sensor is oppositely faced to the edge portion in the widthwise direction of the track, the rotating magnetic field can be detected and thus a magnetic encoder can be structured. Further, in at least an embodiment of the present invention, a sensor face of a magnetic sensor is oppositely faced to the edge portion in the widthwise direction of the track. Therefore, different from a case where a sensor face is perpendicularly directed to a permanent magnet, a condition can be avoided in which the magnetic field does not reach to the saturation sensitivity region at a position far from the permanent magnet and thus detection accuracy can be improved.

In at least an embodiment of the present invention, it is preferable that the track of the permanent magnet comprises a plurality of tracks which is juxtaposed in the widthwise direction and, in the plurality of tracks, positions of the N-poles and the S-poles are shifted with each other in the moving direction in the adjacent tracks. When the positions of the N-poles and the S-poles are shifted with each other in the moving direction in the adjacent tracks, among the edge portions in the widthwise direction of the track, a rotating magnetic field having a large strength is generated at a boundary portion of the tracks. Therefore, when the sensor face of the magnetic sensor is oppositely faced to the above-mentioned boundary portion of the tracks, sensitivity of the magnetic encoder can be improved.

In at least an embodiment of the present invention, it is preferable that the positions of the N-poles and the S-poles in the adjacent tracks are shifted to each other by one magnetic pole in the moving direction.

In at least an embodiment of the present invention, it is preferable that the permanent magnet is provided with two rows of track which are juxtaposed in the widthwise direction.

In at least an embodiment of the present invention, there is a case that the permanent magnet is provided with three or more rows of track which are juxtaposed in the widthwise direction. In this case, it is preferable that the sensor face of the magnetic sensor faces the three or more rows of track in the widthwise direction, and the positions of the N-poles and the S-poles in the moving direction are coincided with each other in the tracks where both end portions of the sensor face are oppositely faced. According to the structure as described above, it is advantageous in that, even when relative position in the widthwise direction between the permanent magnet and the magnetic sensor is shifted, detection sensitivity is not varied.

In at least an embodiment of the present invention, it may be structured that the permanent magnet is provided with one row of track. Even when the track comprises only one row, a rotating magnetic field in which a direction of an in-plane direction is changed is formed at the edge portion in the widthwise direction of the track. Therefore, when the sensor face of the magnetic sensor is oppositely faced to the edge portion of the track, the rotating magnetic field can be detected and a magnetic encoder can be structured.

The magnetic encoder in accordance with at least an embodiment of the present invention is structured as a linear encoder or a rotary encoder. Further, when the magnetic encoder in accordance with at least an embodiment of the present invention is structured as a rotary encoder, the permanent magnet may be formed on an end face or a peripheral face of a rotation body.

At least an embodiment of the present invention utilizes that a rotating magnetic field in which a direction of an in-plane direction is changed is formed at an edge portion in a widthwise direction of a track of a permanent magnet and the rotating magnetic field is detected by means of that a sensor face of a magnetic sensor is oppositely faced to the edge portion in the widthwise direction of the track. Therefore, although a magnetic encoder of a rotating magnetic field detection type is employed, a condition CaO be avoided in which the magnetic field does not reach to the saturation sensitivity region at a position far from the permanent magnet and thus detection accuracy can be improved.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a)-1(c) are respectively a perspective view schematically showing a structure of a magnetic encoder (linear encoder) to which at least an embodiment of the present invention is applied, its cross-sectional view and an explanatory view showing its principle.

FIG. 2 is an explanatory view showing a planar positional relationship between a permanent magnet and a magnetic sensor in a magnetic encoder in accordance with at least an embodiment of the present invention.

FIGS. 3(a)-3(c) are respectively an explanatory planar view showing directions of magnetic field formed in the permanent magnet of the magnetic encoder in accordance with at least an embodiment of the present invention, its explanatory perspective view and its explanatory side view.

FIG. 4 is an explanatory view showing a planar positional relationship between a permanent magnet and a magnetic sensor in a magnetic encoder in accordance with at least an embodiment of the present invention.

FIGS. 5(a)-5(c) are respectively an explanatory planar view showing directions of magnetic field formed in the permanent magnet of the magnetic encoder in accordance with at least an embodiment of the present invention, its explanatory perspective view and its explanatory side view.

FIG. 6 is an explanatory view showing a planar positional relationship between a permanent magnet and a magnetic sensor in a magnetic encoder in accordance with a modified example of at least an embodiment of the present invention.

FIG. 7 is an explanatory view showing a planar positional relationship between a permanent magnet and a magnetic sensor in a magnetic encoder in accordance with at least an embodiment of the present invention.

FIG. 8 is an explanatory view showing a planar positional relationship between a permanent magnet and a magnetic sensor in a magnetic encoder in accordance with at least an embodiment of the present invention.

FIGS. 9(a)-9(c) are respectively an explanatory planar view showing directions of magnetic field formed in the permanent magnet of the magnetic encoder in accordance with at least an embodiment of the present invention, its explanatory perspective view and its explanatory side view.

FIGS. 10(a)-10(b) are respectively an explanatory view showing a rotary encoder which is structured by using a magnetic encoder to which at least an embodiment of the present invention is applied.

FIGS. 11(a)-11(b) are respectively an explanatory view showing a conventional magnetic encoder.

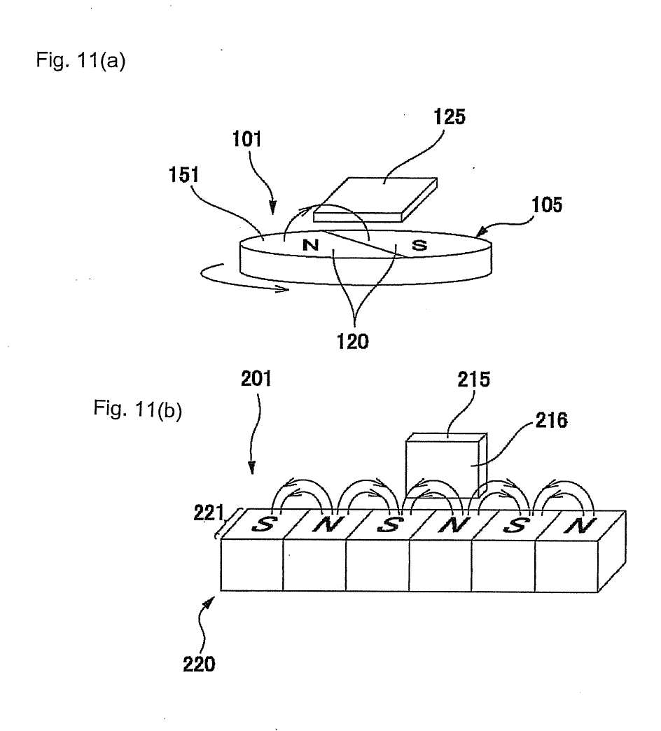

FIGS. 12(a)-12(c) are respectively explanatory views showing a magnetic encoder of a rotating magnetic field detection type.

### DETAILED DESCRIPTION OF PREFERRED EMBODIMENTS

The best mode for carrying out at least an embodiment of the present invention will be described below with reference to the accompanying drawings.

### First Embodiment

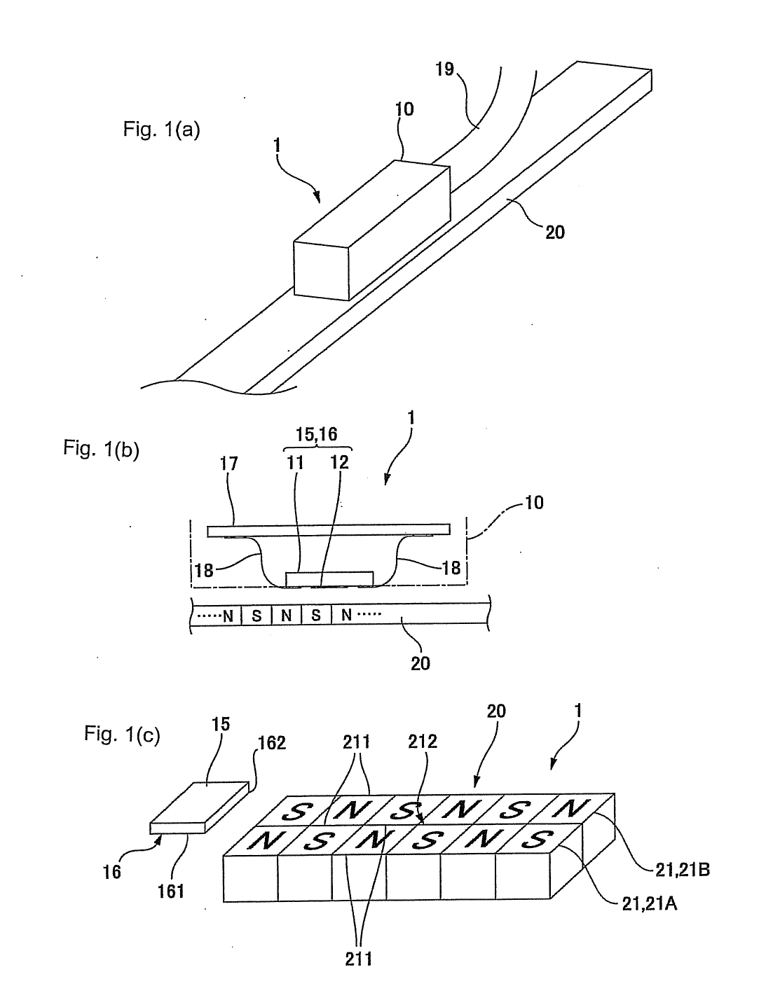

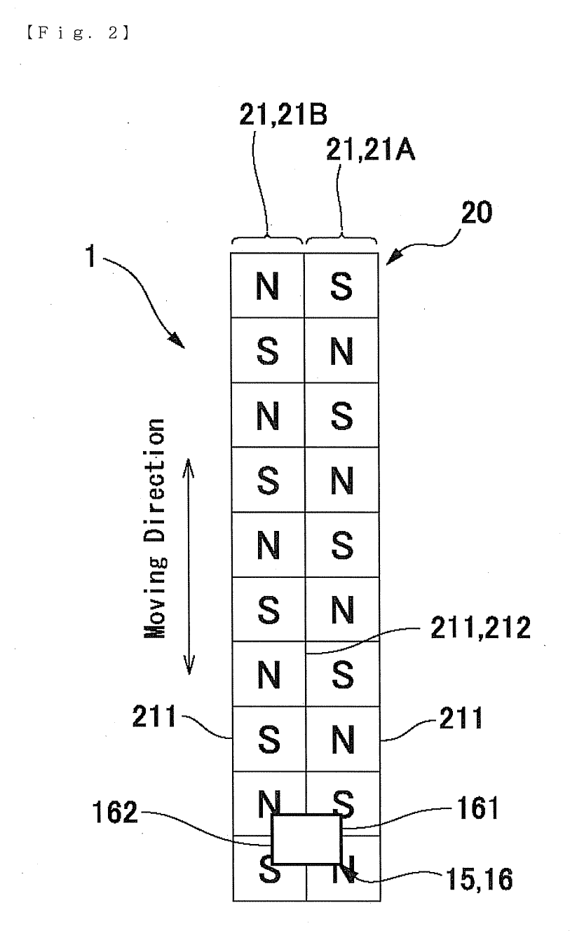

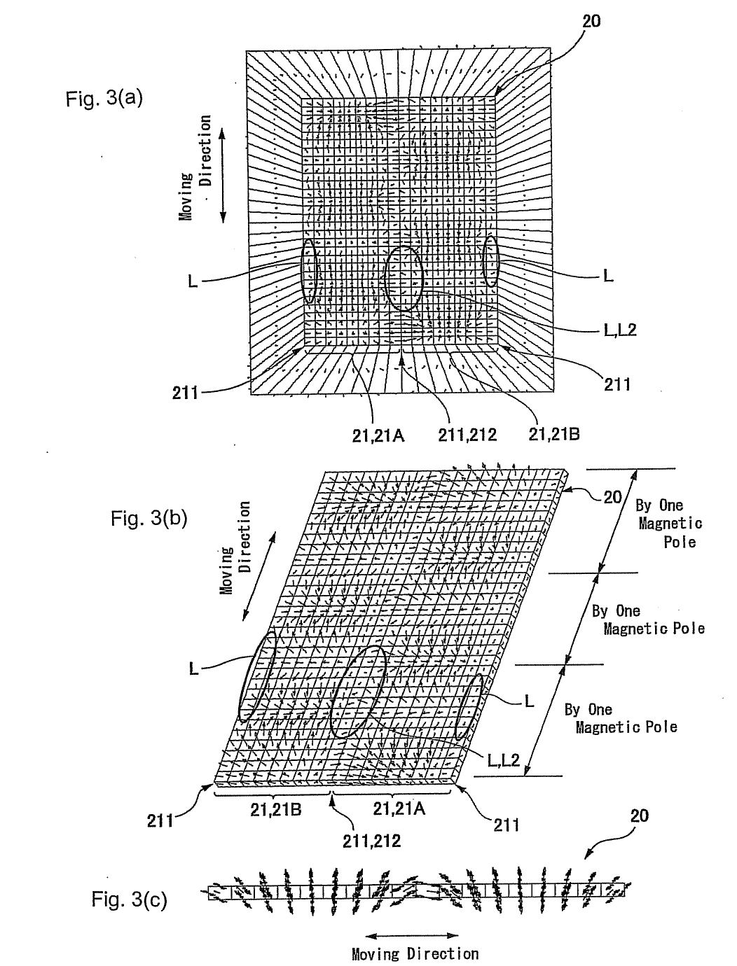

FIGS. 1(a), 1(b) and 1(c) are respectively a perspective view schematically showing a structure of a magnetic encoder (linear encoder) to which at least an embodiment of the present invention is applied, its cross-sectional view and an explanatory view showing its principle. FIG. 2 is an explanatory view showing a planar positional relationship between a permanent magnet and a magnetic sensor in a magnetic encoder in accordance with at least a first embodiment of the present invention. FIGS. 3(a), 3(b) and 3(c) are respectively an explanatory planar view showing directions of magnetic field formed in the permanent magnet of the magnetic encoder in accordance with at least the first embodiment of the present invention, its explanatory perspective view and its explanatory side view.

As shown in FIGS. 1(a), 1(b) and 1(c), a magnetic encoder 1 in this embodiment includes a sensor head 10 with which a cord 19 is connected and a magnetic scale made of a permanent magnet 20 which is extended so as to be in a band shape. The sensor head 10 and the permanent magnet 20 are relatively moved in a longitudinal direction to detect their relative position. For example, in a machine tool or in a mounting device, when one of the sensor head 10 and the permanent magnet 20 is disposed on a fixed body side and the other is disposed on a moving body side, a moving speed and a moving distance of the moving body to the fixed body can be detected.

The sensor head 10 includes in its inside a magnetic sensor 15 which is provided with a magneto-resistive element 12 on a circuit board 11, a circuit board 17, a flexible circuit board 18 connecting the circuit board 17 and the magnetic sensor 15 and the like. A circuit board face of the circuit board 11 functions as a sensor face 16. The circuit board 11 is made of silicon substrate or ceramic glazed substrate. The surface of the circuit board 11 is formed with the magneto-resistive element 12 which is provided with magneto-resistance patterns made of magnetic member film such as ferromagnetic substance NiFe. In accordance with this embodiment, the magneto-resistance patterns structure, for example, Wheatstone bridge or the like. In the circuit board 11 of the magnetic sensor 15, when the side where the magneto-resistive element 12 is formed is made to face the permanent magnet 20 as the sensor face 16, a thin protecting film is formed on its surface. Further, in the circuit board 11 of the magnetic sensor 15, a side opposite to the side where the magneto-resistive element 12 is formed may be used as the sensor face 16.

The permanent magnet 20 is formed with a track 21 having N-poles and S-poles alternately aligned along a moving direction. In this embodiment, two rows of track 21 (21A, 21B) are juxtaposed in a widthwise direction. In addition, the positions of the N-poles and the S-poles are shifted between the two adjacent tracks 21A and 21B by one magnetic pole in the moving direction.

In the magnetic encoder 1 in this embodiment, as described below with reference to FIGS. 3(a)-3(c), the permanent magnet 20 is formed with a rotating magnetic field in which a direction of an in-plane direction is changed at edge portions 211 in the widthwise direction of the tracks 21A and 21B. Especially, among the edge portions 211 in the widthwise direction of the tracks 21A and 21B, at a boundary portion 212 of the adjacent tracks 21A and 21B, the rotating magnetic field whose strength is large is generated.

Therefore, in this embodiment, the sensor face 16 of the magnetic sensor 15 is oppositely faced to the boundary portion 212 of the tracks 21A and 21B. In this embodiment, a width dimension of one track 21 is set to be, for example, 1 mm and a width dimension of the sensor face 16 is set to be, for example, 1 mm. Further, the sensor face 16 is located at the center in the widthwise direction of the permanent magnet 20. Therefore, one end part 161 in the widthwise direction of the sensor face 16 is located at the center in the widthwise direction of one track 21A and the other end part 162 is located at the center in the widthwise direction of the other track 21B.

In the magnetic encoder 1 structured as described above, the direction in the in-plane direction of the magnetic field of the permanent magnet 20 has been analyzed with magnetic field analysis for each matrix-shaped fine region. As a result, as shown by arrows in FIGS. 3(a), 3(b) and 3(c), in the edge portions 211 in the widthwise direction of the tracks 21A and 21B, a rotating magnetic field in which a direction of the in-plane direction is changed is formed as shown in regions surrounded by the circle “L”. Especially, among the edge portions 211 in the widthwise direction of the tracks 21A and 21B, at the boundary portion 212 between the adjacent tracks 21A and 21B, a rotating magnetic field having large strength is generated as shown in the region surrounded by the circle “L2”.

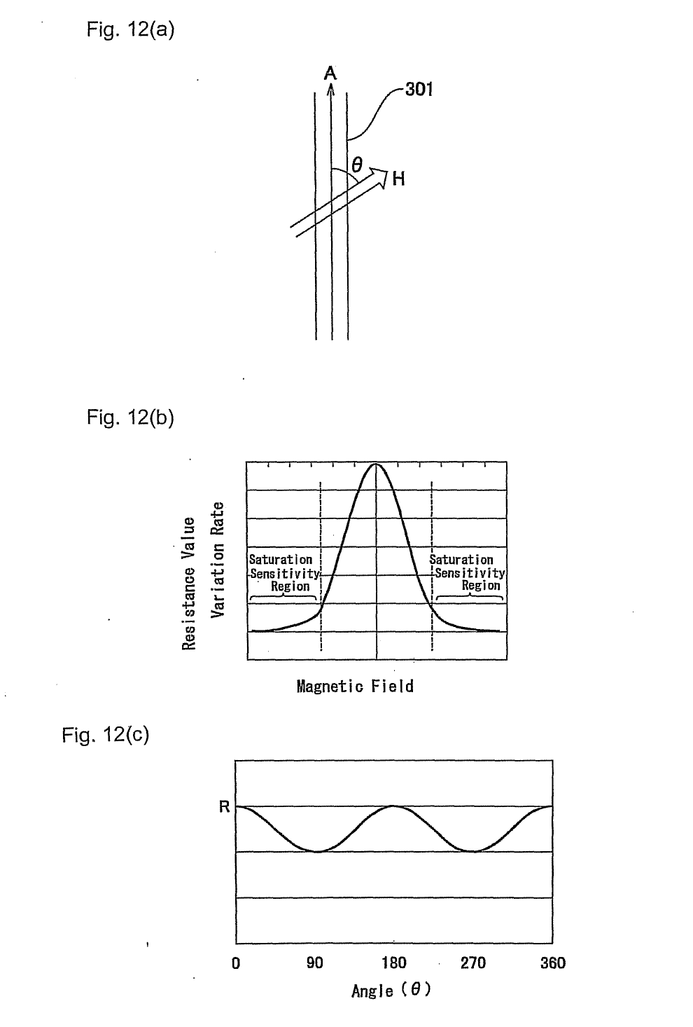

The detection principle of a rotating magnetic field type has been already described with reference to FIGS. 12(a)-12(c) and thus its description is omitted. In the magnetic encoder 1 of this embodiment, the rotating magnetic field which is formed at the boundary portion 212 between the adjacent tracks 21A and 21B of the permanent magnet 20 can be detected by the magnetic sensor 15. Therefore, a relative moving speed and a relative moving distance between the sensor head 10 and the permanent magnet 20 can be detected on the basis of the result. Accordingly, a sine wave with a high degree of waveform quality can be obtained from the magnetic sensor 15 and, in addition, the magnetic sensor 15 is strong to a disturbance magnetic field. In other words, the feature of the rotating magnetic field detection type can be exhibited to the maximum possible extent. Moreover, the saturation sensitivity region is utilized and thus a high degree of detection sensitivity can be obtained without being affected by manufacturing dispersion of the magneto-resistive element 12.

Further, in this embodiment, the sensor face 16 of the magnetic sensor 15 is oppositely faced to the boundary portion 212 between the tracks 21A and 21B to detect the rotating magnetic field. Therefore, different from a case where a sensor face is perpendicularly directed to the permanent magnet 20, a condition can be avoided in which the magnetic field does not reach to the saturation sensitivity region at a position far from the permanent magnet 20. Accordingly, even when mounting accuracy of the magnetic sensor 15 is low, detection accuracy of the magnetic encoder 1 can be improved.

This embodiment is structured such that the end parts 161 and 162 in the widthwise direction of the sensor face 16 are respectively located at the center in the widthwise direction of the tracks 21A and 21B. However, it may be structured that the width dimension of the sensor face 16 is wider than the width dimension of the permanent magnet 20 such that the end parts 161 and 162 of the sensor face 16 are protruded on outer sides in the widthwise direction of the permanent magnet 20.

### Second Embodiment

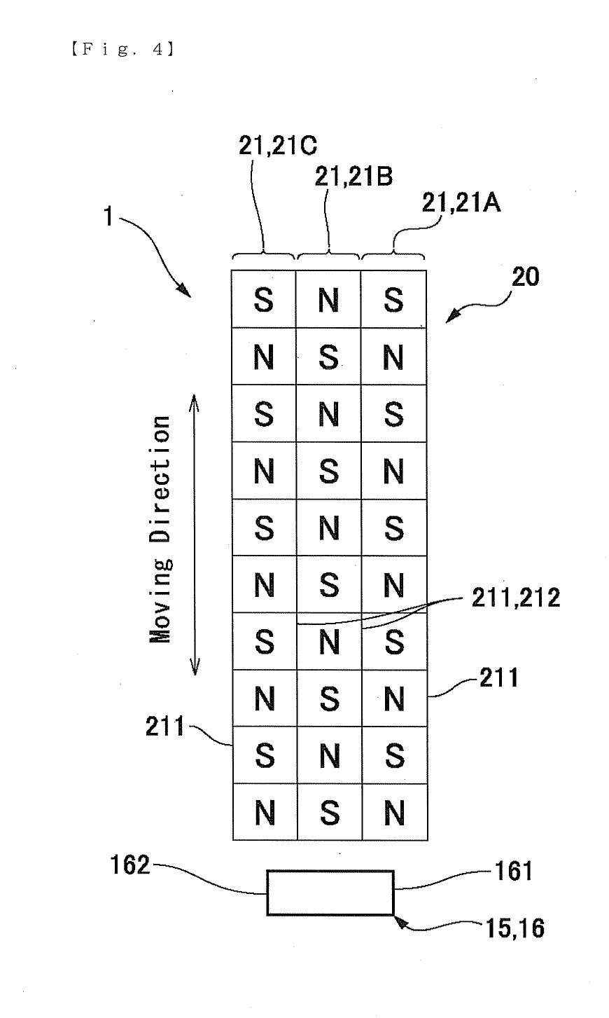

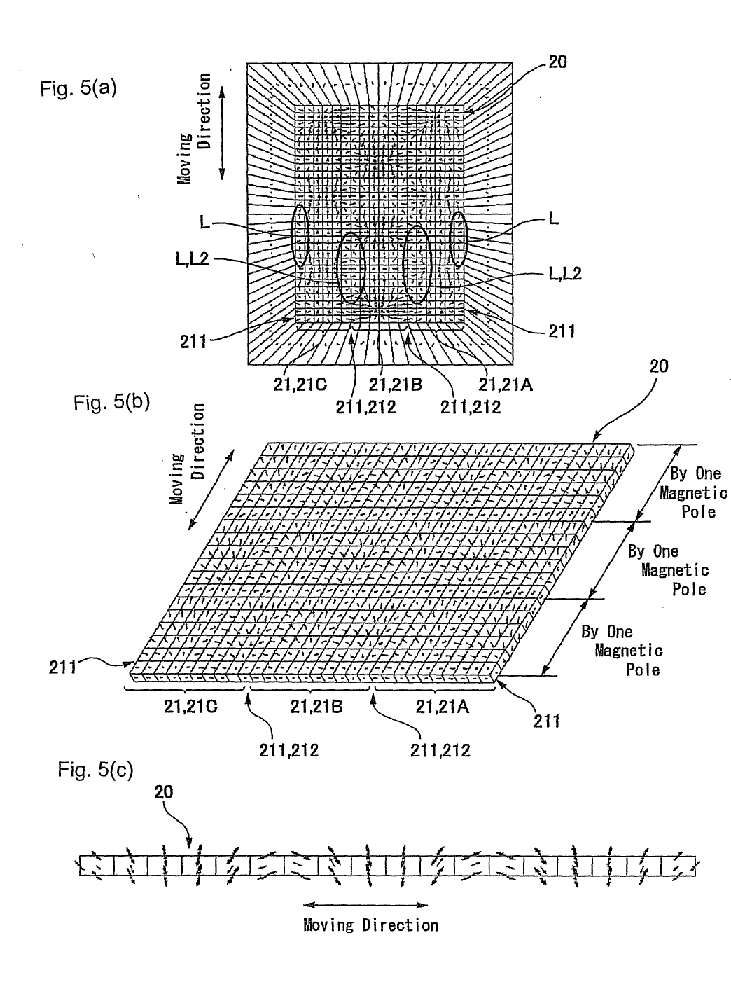

FIG. 4 is an explanatory view showing a planar positional relationship between a permanent magnet and a magnetic sensor in a magnetic encoder in accordance with at least a second embodiment of the present invention. FIGS. 5(a), 5(b) and 5(c) are respectively an explanatory planar view showing directions of magnetic field formed in the permanent magnet of the magnetic encoder in accordance with at least the second embodiment of the present invention, its explanatory perspective view and its explanatory side view. A basic structure of the second embodiment is common to that of the first embodiment and thus the same notational symbols are used in common portions and their descriptions are omitted.

As shown in FIG. 4, a magnetic encoder 1 of this embodiment also includes, similarly to the first embodiment, a magnetic sensor 15 and a permanent magnet 20. The permanent magnet is formed with a track 21 having N-poles and S-poles alternately aligned along a moving direction. In this embodiment, three rows of track 21 (21A, 21B and 21C) are juxtaposed in a widthwise direction. In addition, the positions of the N-poles and the S-poles are shifted by one magnetic pole in the moving direction between the two adjacent tracks 21A and 21B, and the positions of the N-poles and the S-poles are shifted by one magnetic pole in the moving direction between the two adjacent tracks 21B and 21C. Therefore, the positions of the N-poles and the S-poles of the two tracks 21A and 21C are coincided with each other in the moving direction.

In the magnetic encoder 1 in this embodiment, as described below with reference to FIGS. 5(a)-5(c), the permanent magnet 20 is formed with a rotating magnetic field in which a direction of an in-plane direction is changed at edge portions 211 in the widthwise direction of the tracks 21A, 21B and 21C. Especially, the rotating magnetic field whose strength is large is generated at a boundary portion 212 of the adjacent tracks 21A and 21B and at a boundary portion 212 of the adjacent tracks 21B and 21C.

Therefore, in this embodiment, the sensor face 16 of the magnetic sensor 15 is oppositely faced to the boundary portions 212 of the tracks 21A, 21B and 21C. In this embodiment, a width dimension of one track 21 is set to be, for example, 1 mm and a width dimension of the sensor face 16 is set to be, for example, 2 mm. Further, the sensor face 16 is located at the center in the widthwise direction of the permanent magnet 20. Therefore, one end part 161 in the widthwise direction of the sensor face 16 is located at the center in the widthwise direction of one track 21A and the other end part 162 is located at the center in the widthwise direction of the other track 21C.

In the magnetic encoder 1 structured as described above, the direction of the in-plane direction of the magnetic field of the permanent magnet 20 has been analyzed with magnetic field analysis for each matrix-shaped fine region. As a result, as shown by arrows in FIGS. 5(a), 5(b) and 5(c), in the edge portions 211 in the widthwise direction of the tracks 21A, 21B and 21C, a rotating magnetic field in which a direction of the in-plane direction is changed is formed as shown in regions surrounded by the circle “L”. Especially, among the edge portions 211 in the widthwise direction of the tracks 21A, 21B and 21C, at the boundary portions 212 between the adjacent tracks 21A, 21B and 21C, a rotating magnetic field having a large strength is generated as shown in the region surrounded by the circle “L2”.

Therefore, in the magnetic encoder 1 of this embodiment, the rotating magnetic field which is formed at the boundary portions 212 between the adjacent tracks 21A, 21B and 21C of the permanent magnet 20 can be detected by the magnetic sensor 15. Accordingly, a relative moving speed and a relative moving distance between the sensor head 10 and the permanent magnet 20 can be detected on the basis of the result.

Further, in this embodiment, the sensor face 16 of the magnetic sensor 15 is oppositely faced to the boundary portions 212 between the tracks 21A, 21B and 21C to detect the rotating magnetic field. Therefore, different from a case where a sensor face is perpendicularly directed to the permanent magnet 20, a condition can be avoided in which the magnetic field does not reach to the saturation sensitivity region at a position far from the permanent magnet 20 and thus detection accuracy of the magnetic encoder 1 can be improved.

In addition, in this embodiment, the sensor face 16 of the magnetic sensor 15 faces three rows of tracks 21A, 21B and 21C in the widthwise direction, and the positions of the N-poles and the S-poles of the two tracks 21A and 21C to which both end portions of the sensor face 16 are faced are coincided with each other in the moving direction. Therefore, it is advantageous in that, even when the relative position in the widthwise direction between the permanent magnet 20 and the magnetic sensor 15 is shifted, detection sensitivity is not varied.

### [Modified Example of Second Embodiment]

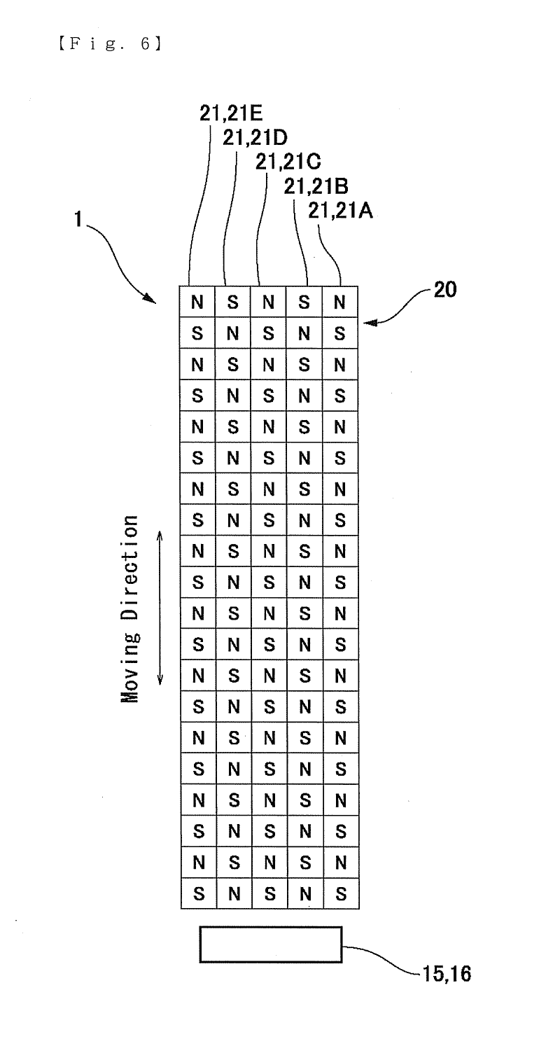

FIG. 6 is an explanatory view showing a planar positional relationship between a permanent magnet and a magnetic sensor in a magnetic encoder in accordance with at least a modified example of the second embodiment of the present invention.

In the embodiment described with reference to FIG. 4, the number of tracks is 3. However, as shown in FIG. 6, it may be structured such that the sensor face 16 faces five rows of tracks 21A, 21B, 21C, 21D and 21E in the widthwise direction, and the positions of the N-poles and the S-poles of the two tracks 21A and 21E to which both end portions of the sensor face 16 are faced are coincided with each other in the moving direction. Even in a case structured as described above, similarly to the second embodiment, it is advantageous in that, even when the relative position in the widthwise direction between the permanent magnet 20 and the magnetic sensor 15 is shifted, detection sensitivity is not varied.

### [Modified Example of First and Second Embodiments]

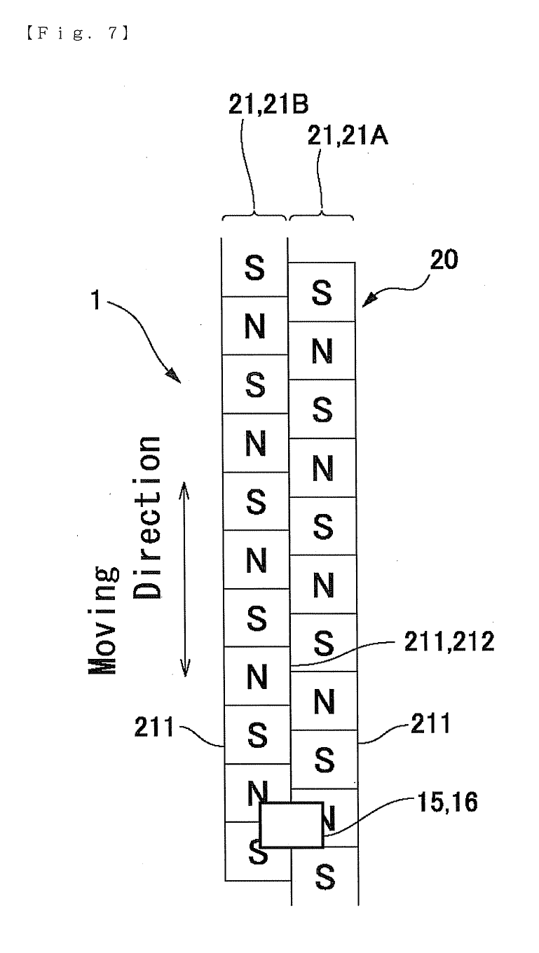

FIG. 7 is an explanatory view showing a planar positional relationship between a permanent magnet and a magnetic sensor in a magnetic encoder in accordance with at least a modified example of the first and the second embodiments of the present invention.

In the first and second embodiments, the positions of the N-poles and the S-poles are shifted by one magnetic pole in the moving direction between the two adjacent tracks 21A and 21B. However, as shown in FIG. 7, it may be structured such that the positions of the N-poles and the S-poles are shifted by only ½ (half) magnetic pole in the moving direction between the two adjacent tracks 21A and 21B. Even in a case structured as described above, the rotating magnetic field which is generated at the boundary portion between the adjacent tracks 21A and 21B can be detected by the magnetic sensor 15.

### Third Embodiment

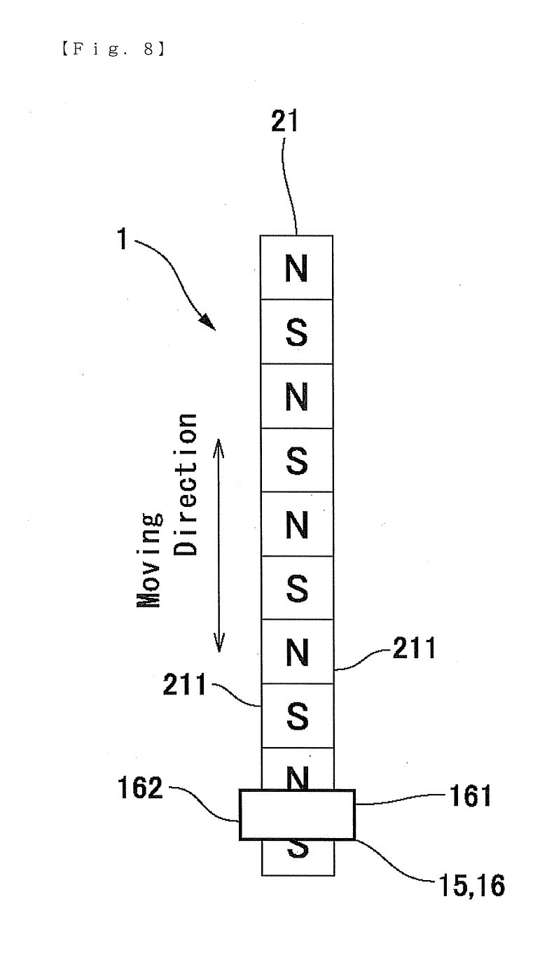

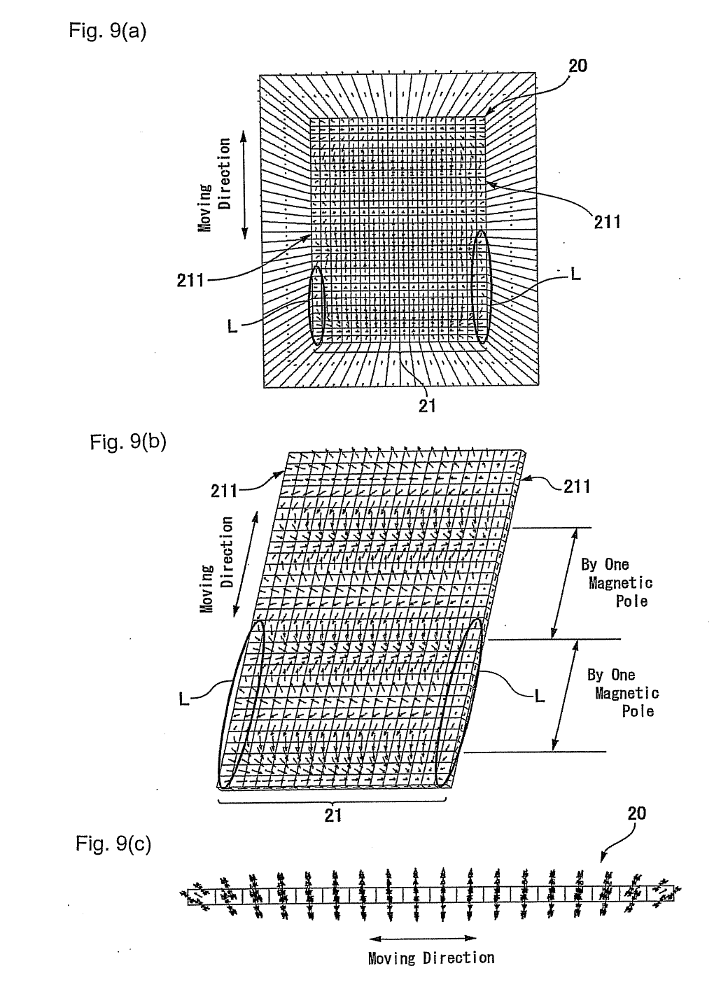

FIG. 8 is an explanatory view showing a planar positional relationship between a permanent magnet and a magnetic sensor in a magnetic encoder in accordance with at least a third embodiment of the present invention. FIGS. 9(a), 9(b) and 9(c) are respectively an explanatory planar view showing directions of magnetic field formed in the permanent magnet of the magnetic encoder in accordance with at least the third embodiment of the present invention, its explanatory perspective view and its explanatory side view. A basic structure of this embodiment is common to that of the first embodiment and thus the same notational symbols are used in common portions and their descriptions are omitted.

As shown in FIG. 8, a magnetic encoder 1 of this embodiment also includes, similarly to the first embodiment, a magnetic sensor 15 and a permanent magnet 20. The permanent magnet is formed with a track 21 having N-poles and S-poles alternately aligned along a moving direction. In this embodiment, one row of track 21 is formed.

In the magnetic encoder 1 in this embodiment, as described below with reference to FIGS. 9(a)-9(c), the permanent magnet 20 is formed with a rotating magnetic field in which a direction of an in-plane direction is changed at edge portions 211 in the widthwise direction of the track 21A.

Therefore, in this embodiment, the sensor face 16 of the magnetic sensor 15 is oppositely faced to the edge portions 211 of the track 21A. In this embodiment, a width dimension of the track 21 is set to be, for example, 1 mm and a width dimension of the sensor face 16 is set to be, for example, 2 mm. Further, since the track 21 is located at the center in the widthwise direction of the sensor face 16, the end parts 161 and 162 in the widthwise direction of the sensor face 16 are protruded on the outer sides in the widthwise direction of the track 21.

In the magnetic encoder 1 structured as described above, the direction of the in-plane direction of the magnetic field of the permanent magnet 20 has been analyzed with magnetic field analysis for each matrix-shaped fine region. As a result, as shown by arrows in FIGS. 9(a), 9(b) and 9(c), in the edge portions 211 in the widthwise direction of the track 21, a rotating magnetic field in which a direction of the in-plane direction is changed is formed as shown in regions surrounded by the circle “L”.

Therefore, in the magnetic encoder 1 of this embodiment, the rotating magnetic field which is formed at the edge portions 211 of the track 21 can be detected by the magnetic sensor 15. Therefore, a relative moving speed and a relative moving distance between the sensor head 10 and the permanent magnet 20 can be detected on the basis of the result.

### Other Embodiments

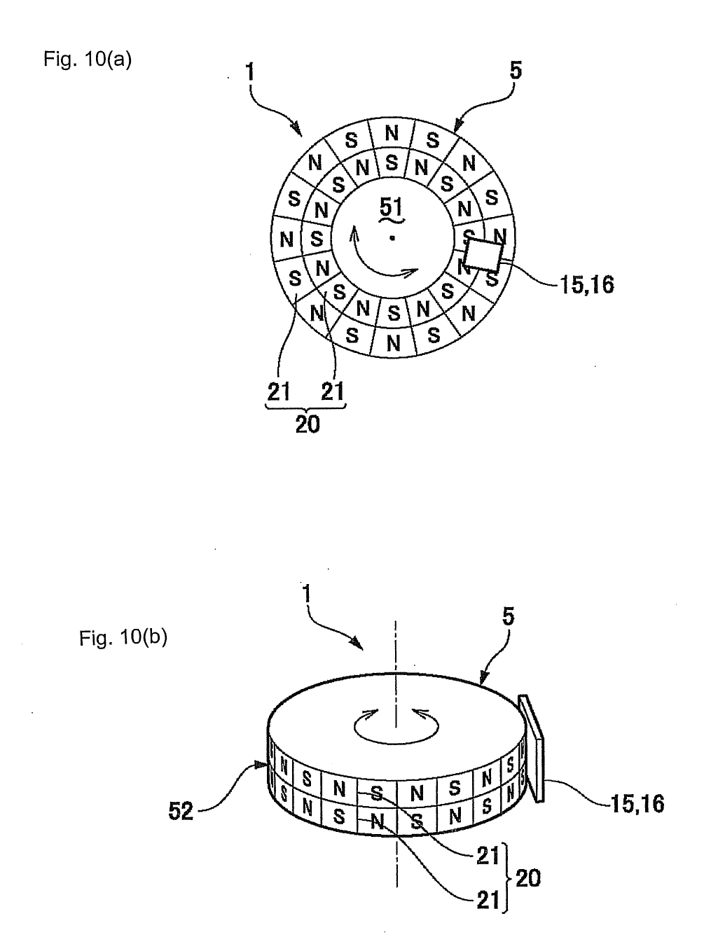

In all the embodiments described above, the magnetic encoder is structured as a linear encoder. However, as shown in FIGS. 10(a) and 10(b), a rotary encoder may be structured by using the magnetic encoder 1. In this case, as shown in FIG. 10(a), a permanent magnet 20 may be structured such that tracks 21 are extended in a circumferential direction on an end face 51 of a rotation body 5, and a sensor face 16 of a magnetic sensor 15 is oppositely faced to the tracks 21 structured as described above. Alternatively, as shown in FIG. 10(b), a permanent magnet 20 may be structured such that tracks 21 are extended in a circumferential direction on an outer peripheral face 52 of a rotation body 5 and a sensor face 16 of a magnetic sensor 15 is oppositely faced to the tracks 21 structured as described above.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A magnetic encoder comprising:
a magnetic sensor which is provided with a magneto-resistive element on a sensor face of the magnetic sensor; and
a permanent magnet which is moved relative to the magnetic sensor and which is formed with a track having N-poles and S-poles alternately aligned along a moving direction;
wherein the sensor face of the magnetic sensor is oppositely faced to an edge portion in a widthwise direction of the track and the magnetic sensor detects a rotating magnetic field in which a direction of an in-plane direction is changed at the edge portion.

2. The magnetic encoder according to claim 1, wherein the track of the permanent magnet comprises a plurality of tracks which is juxtaposed in the widthwise direction and, in the plurality of tracks, positions of the N-poles and the S-poles are shifted with each other in the moving direction in the adjacent tracks.

3. The magnetic encoder according to claim 2, wherein in the plurality of tracks, the positions of the N-poles and the S-poles in the adjacent tracks are shifted to each other by one magnetic pole in the moving direction.

4. The magnetic encoder according to claim 3, wherein the permanent magnet is provided with two rows of track which are juxtaposed in the widthwise direction.

5. The magnetic encoder according to claim 2, wherein
the permanent magnet is provided with three or more rows of track which are juxtaposed in the widthwise direction, and
the sensor face of the magnetic sensor faces the three or more rows of track in the widthwise direction, and
the positions of the N-poles and the S-poles in the moving direction are coincided with each other in the tracks where both end portions of the sensor face are oppositely faced.

6. The magnetic encoder according to claim 1, wherein the permanent magnet is provided with one row of track.

7. The magnetic encoder according claim 5, wherein the magnetic encoder is structured as a linear encoder or a rotary encoder.

8. The magnetic encoder according to claim 7, wherein the magnetic encoder is structured as a rotary encoder in which the permanent magnet is formed on an end face or a peripheral face of a rotation body.

9. The magnetic encoder according to claim 3, wherein
the permanent magnet is provided with three or more rows of track which are juxtaposed in the widthwise direction, and
the sensor face of the magnetic sensor faces the three or more rows of track in the widthwise direction, and
the positions of the N-poles and the S-poles in the moving direction are coincided with each other in the tracks where both end portions of the sensor face are oppositely faced.

10. The magnetic encoder according claim 9, wherein the magnetic encoder is structured as a linear encoder or a rotary encoder.

11. The magnetic encoder according to claim 10, wherein the magnetic encoder is structured as a rotary encoder in which the permanent magnet is formed on an end face or a peripheral face of a rotation body.
